(19) United States
(12) Patent Application Publication
(10) Pub. No.: US 2007/0126560 A1
(43) Pub. Date: Jun. 7, 2007

(54) Method and system for vehicle security

(76) Inventors: Shafer B. Seymour, Bartlett, IL (US); Ramy P. Ayoub, Arlington Heights, IL (US)

Correspondence Address: MOTOROLA, INC., 1303 EAST ALGONQUIN ROAD, IL01/3RD, SCHAUMBURG, IL, 60196, US

(21) Appl. No.: 11/294,067

(22) Filed: Dec. 2, 2005

(51) Int. Cl. B60R 25/10; B60R 25/00; B62H 5/00

(52) U.S. Cl. 340/426.1; 180/287; 307/10.2; 701/36

(57) ABSTRACT

The present invention provides a method and a system for vehicle security implemented in a vehicle (106). The method includes scanning one or more fingers of a user of the vehicle (106) by using a scanner (102). Based on the information received from the scanner (102), a controller (104) determines the security mode to be implemented in the vehicle (106). The determined security mode is then implemented by the controller (104), thereby making the vehicle (106) secure.

### FIELD OF THE INVENTION

The present invention relates generally to the field of vehicle security. In particular, the present invention relates to the use of fingerprint scanners in vehicle security.

### BACKGROUND OF THE INVENTION

One of the fastest growing areas in communication technology pertains to telematics control units embedded in vehicles. A telematics control unit provides functions such as locking the doors of a vehicle, disabling an alarm, determining the location of a vehicle, accessing call-center information, and various other security features.

These security features may include communication with other vehicles, communication with a central server, tracking and positioning, on-line navigation, communication with emergency services, etc. In addition, the telematics control unit may have a direct interface with the vehicle's electronic and on-board computer-based systems. The use of telematics alone as a security feature, however, may not enable functions that are specific to the user of a vehicle.

### BRIEF DESCRIPTION OF THE DRAWINGS

The present invention is illustrated by way of example, and not limitation in the accompanying figures, in which like references indicate similar elements, and in which:

FIG. 1 is an exemplary environment illustrating a vehicle security system, in accordance with one embodiment of the present invention;

FIG. 2 is a block diagram illustrating a controller in the vehicle security system, in accordance with one embodiment of the present invention; and

FIG. 3 is a flow diagram illustrating a method for making a vehicle secure, in accordance with one embodiment of the present invention.

Skilled artisans will appreciate that elements in the figures are illustrated for simplicity and clarity and have not necessarily been drawn to scale. For example, the dimensions of some of the elements in the figures may be exaggerated relative to other elements, to help to improve understanding of embodiments of the present invention.

### DETAILED DESCRIPTION OF THE FIGURES

In an embodiment of the present invention, a method for making a vehicle secure has been provided. The vehicle has a plurality of security modes. The security mode to be implemented is determined based on the scanning of at least one finger of the user of the vehicle. A fingerprint scanner is used for scanning the at least one finger of the user.

In another embodiment of the present invention, a vehicle security system is provided, which has a scanner and a controller. The scanner can be used to scan at least one finger of a user of the vehicle. The controller is associated with the scanner and is used to implement at least one of a number of security modes. Each security mode that can be implemented by using the controller can be associated with at least one finger of the user of the vehicle. Depending on the finger scanned, the controller can select and implement a security mode to make the vehicle secure.

In yet another embodiment of the present invention, a method for making a vehicle secure by using a number of security modes is provided. The security modes that can be implemented include a normal mode and an emergency mode. The normal mode may be associated with a first set of fingers of a user of the vehicle, while the emergency mode can be associated with a second set of fingers of the user. In this method, a scanner scans at least one finger of the user. A particular security mode is selected, based on the finger scanned by the user. The vehicle is made secure, based on the security mode selected.

Before describing in detail a method and system for vehicle security, in accordance with the present invention, it should be observed that the present invention resides primarily in combinations of method steps and apparatus components related to making the vehicle secure. Accordingly, the apparatus components and method steps have been represented, where appropriate, by conventional symbols in the drawings. These drawings show only the specific details that are pertinent for understanding the present invention, so as not to obscure the disclosure with details that will be apparent to those with ordinary skill in the art and the benefit of the description herein.

In this document, relational terms, such as first and second, and the like, may be used, solely to distinguish one entity or action from another entity or action, without necessarily requiring or implying any actual such relationship or order between such entities or actions. The terms “comprises”, “comprising”, or any other variation thereof, are intended to cover a non-exclusive inclusion, such that a process, method, article, or apparatus that comprises a list of elements does not include only those elements but may include other elements not expressly listed or inherent to such a process, method, article, or apparatus. An element proceeded by “comprises . . . a” does not, without more constraints, preclude the existence of additional identical elements in the process, method, article or apparatus that comprises the element.

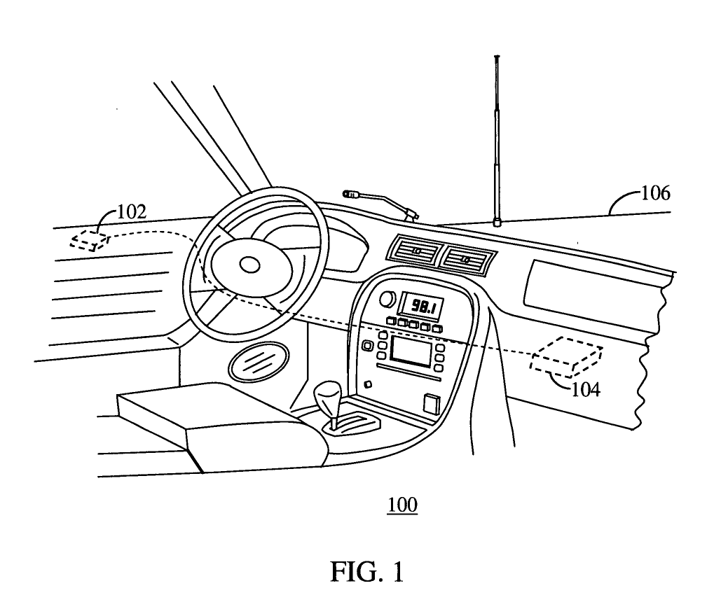

Referring now to the figures, FIG. 1 is an exemplary environment illustrating a vehicle security system 100, in accordance with one embodiment of the present invention. The vehicle security system 100 includes a scanner 102 and a controller 104. The vehicle security system 100 can be installed inside a vehicle 106, and can be configured to make the vehicle 106 secure by using various security modes. In one embodiment of the present invention, the scanner 102 can be installed on the dashboard or on the center console, of the vehicle 106, to make it easily accessible to the user. In another embodiment of the present invention, the scanner 102 may additionally, or alternatively, be installed on one of the doors of the vehicle 106. Examples of the scanner 102 include, but are not limited to, an optical scanner, a capacitance scanner, a thermal scanner, and so forth. The scanner 102, installed in the vehicle 106, is used to scan at least one finger of the user. The scanner may also have supplementary functions, such as the ability to detect heart rate, body temperature and other biometric information. The information scanned by the scanner 102 is used by the controller 104 to implement one or more of a plurality of security modes. Each security mode is associated with at least one finger of the user of the vehicle 106.

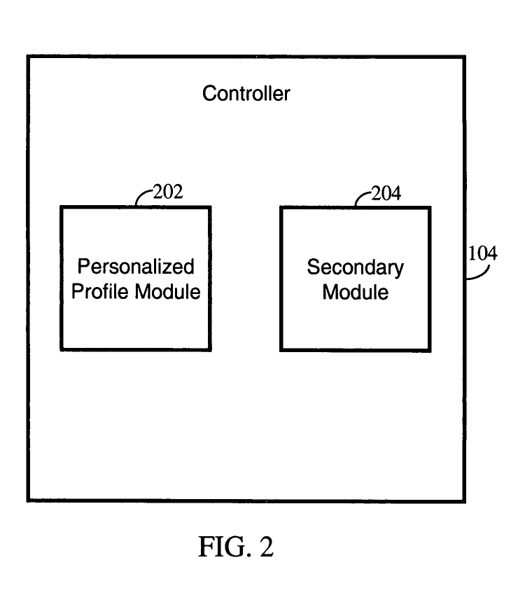

FIG. 2 is a block diagram illustrating a controller 104 in the vehicle security system 100, in accordance with one embodiment of the present invention. The controller 104 includes a personalized profile module 202 and a secondary module 204. The vehicle 106 may typically be used by a number of users, for example, by the members of a family or in a car rental service. These situations require the vehicle security system 100 to recognize all authorized users, and enable them to use the vehicle 106. The vehicle security system 100 can recognize multiple users, based on the fingers scanned. Further, a user may implement a personalized profile in the vehicle 106 by scanning a predefined set of fingers. The personalized profile can include various personalization parameters, such as the positioning of a seat and of mirrors, radio station presets, and so forth. A plurality of personalized profiles can be stored in the vehicle security system 100, each personalized profile being used by one of the plurality of users. The personalized profile module 202 can be used to automatically activate a personalized profile from amongst the stored personalized profiles of the present user.

In one embodiment of the present invention, the vehicle security system 100 can be configured to operate in at least one of a plurality of security modes. Examples of these security modes include, but are not limited to, a normal mode, an emergency mode, a disable mode, a guest mode, and a security disable mode.

The normal mode can be configured to enable the vehicle 106 to function normally; the emergency mode can be configured to allow transmission of an emergency signal. The emergency signal may include a position update of the vehicle 106, which can use global positioning system (GPS) technology. The emergency signal may also include a transmission process that enables Telematics service providers or law enforcement agencies to ascertain the current location of the vehicle 106. In one embodiment of the present invention, the emergency signal can be a short messaging service (SMS) message or an email. The emergency signal can be transmitted either continuously by the vehicle security system 100 or periodically within a short, fixed length of time in-between the periodic transmissions.

The disable mode can be configured to completely disable the vehicle 106, and may be particularly useful in cases where the user needs to disable all the functions of the vehicle 106. Once activated, the disable mode deactivates all activity in the vehicle 106, thereby pre-empting the possibility of the vehicle 106 being stolen. The disable mode can be made inactive by, for example, entering a key-string or an identification number through a user interface that can be provided in the car for this purpose.

The guest mode enables a non-registered user to use the vehicle 106. It may be necessary for the vehicle 106 to be used by a user who is not authorized by the vehicle security system 100 to do so. Such a user can be referred to as an unauthorized user or a non-registered user. The vehicle security system 100 can be configured to allow the vehicle 106 to be used in the guest mode. In various embodiments of the present invention, the guest mode has various built-in restrictions, such as enabling only certain features or functionalities of the vehicle 106, which may be collectively referred to as secondary features. In various embodiments of the invention, the secondary module 204 enables the secondary features of the vehicle 106. These secondary features can also include functionalities such as the geographical containment and speed limitation of the vehicle 106. The geographical containment of the vehicle 106 can stop the guest user from driving the vehicle 106 out of a particular geographical area. A speed limitation can disallow the guest user from driving above a certain speed limit. These secondary features can be stored in the vehicle security system 100 by an authorized user, by utilizing a user interface.

The security disable mode can be configured to enable disablement of all security features in the vehicle 106. The security disable mode may be useful in situations and areas where the user thinks there is no need to activate the vehicle security system 100. Implementing the security disable mode ensures that false alarms are not raised and transmitted to law enforcement agencies. The security disable mode may also be useful in a situation where a potential thief or miscreant threatens the user with physical injury.

In various embodiments of the present invention, the vehicle security system 100 can be configured to provide varying levels of security. In one embodiment of the present invention, the vehicle security system 100 can be configured to the highest level of sensitivity, whereby an alarm is raised if any finger, apart from a pre-determined finger of the user, is scanned. The vehicle security system 100 can also be configured to require a particular sequence of finger scans, to enable the various security modes of the vehicle security system 100. An alarm may be raised if any other finger, apart from the pre-determined sequence of fingers, is scanned.

In various embodiments of the present invention, the vehicle security system 100 can be configured to detect if all the doors of the vehicle 106 are closed, and subsequently verify the identity of the occupants of the vehicle 106. The vehicle security system 100 can be configured to require that once all the doors of the vehicle 106 are secured, all occupants of the vehicle 106 must use the scanner 102 to verify their identity, before the vehicle 106 can be started. This can prevent unauthorized occupants from entering and using the vehicle 106. In an embodiment of the present invention, the vehicle security system 100 can be configured to detect the number of occupants in the vehicle 106 using any known occupant detection system, including, but not limited to those based on seated weight of the occupants, the seat belt tension, a comparison of a current input from a still image sensor with a control image, a motion capture system, an infra-red sensor based system, an electric field sensor based system, and any other active or passive occupant detection system. The vehicle security system 100 can be configured to prevent the vehicle 106 from being started unless verification of each occupant in the vehicle 106 is completed. In an embodiment of the present invention, if the vehicle 106 is attempted to be started without verification of all of its occupants, or at least a subset thereof (depending on the configuration), the vehicle security system 100 can transmit an emergency signal to the Telematics service providers or law enforcement agencies. In an embodiment of the present invention, the vehicle security system 100 can be configured to disallow the addition of occupant profiles into it. This can prevent an unauthorized person from coercing an authorized occupant into adding his profile to the vehicle security system 100 as an authorized user. In an embodiment of the present invention, the vehicle security system 100 can allow the addition of user profiles only when the vehicle 106 is located at a particular geographical location.

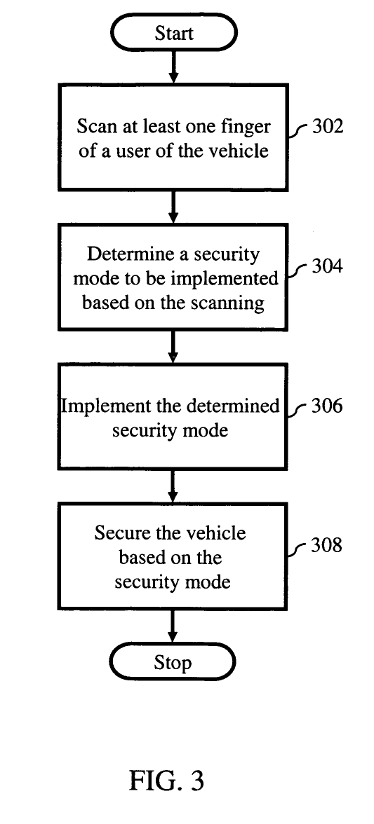

FIG. 3 is a flow diagram illustrating a method for making the vehicle 106 secure, in accordance with one embodiment of the present invention. At step 302, at least one finger of the user of the vehicle 106 is scanned by the scanner 102. As described above, the user may scan a particular finger or a sequence of fingers, to activate the security mode associated with the finger or the sequence of fingers. At step 304, the security mode to be implemented by the user is determined, based on the finger or sequence of finger scanned by the scanner 102. At step 306, the security mode that has been determined is implemented, and as a result, the vehicle 106 is made secure at step 308.

In various embodiments of the present invention, the vehicle security system 100 can be configurable by the user. The user can configure the vehicle security system 100 using a security code that can be provided by the manufacturer of the vehicle 106. The user can program the plurality of security modes into the vehicle security system 100 by selecting a security mode and presenting one finger, multiple fingers simultaneously, or multiple fingers sequentially to be associated to that security mode.

As described above, the vehicle security system 100 can be configured to operate in any of the plurality of security modes available. In the normal mode, the personalized profile of the present user of the vehicle 106 can be automatically activated, as soon as the user gets one or more of his fingers scanned. In another embodiment of the present invention, the vehicle security system 100 can be configured to operate in the emergency mode, for which a plurality of danger levels can be configured. A lower danger level may be set for areas where the user perceives the need for the vehicle security system 100 to be low. Correspondingly, a higher danger level may be set for areas with a higher perceived need for security. The plurality of danger levels can each be configured to a pre-determined finger of the user or a combination of the user's fingers that are being scanned. At the high danger-level configuration, the vehicle security system 100 can allow normal use of the vehicle 106 only if a particular finger of the user is scanned. For all other actions, an alarm is raised and the emergency signal transmitted by the vehicle security system 100. At the low danger-level configuration, a sequence of finger scans may be required to raise an alarm. This is to prevent false alarms being raised when the vehicle 106 is located in a region where there is a low perceived need for the vehicle security system 100. In an embodiment of the present invention, in addition to the finger scans, other biometric data can be utilized to determine whether the user is acting normally or is under duress. Examples of other biometric data include, but are not limited to, the heart rate, perspiration, retinal size, voice pattern, facial characteristics, and so forth, of the user. The vehicle security system 100 can utilize any of these biometric data, in conjunction with the finger scan, to evaluate whether the user is actually making a request for an alarm to be raised.

In various embodiments of the present invention, the user selects a danger level manually and can utilize a user interface that can be provided on the vehicle security system 100 to select the danger level. In one embodiment of the present invention, the danger level can be selected automatically by the vehicle security system 100, based on the geographical location mapping of the vehicle 106. The geographical location mapping of the vehicle 106 can be based on the GPS data available or on any other location determination technique. The automatic selection of the danger level can also enable the vehicle security system 100 to dynamically change the danger-level configuration, depending on the location of the vehicle 106 while the user is driving. The benefit of this automatic configuration is that it enables the vehicle security system 100 to provide the most appropriate level of protection when the vehicle 106 is being driven. This is because, while being driven, the vehicle 106 may be entering and exiting multiple areas with their specific levels of the perceived danger level.

Various embodiments of the present invention provide a method and a system that allow the user of the vehicle 106 to make the vehicle secure. This is achieved by configuring a plurality of security modes in the vehicle security system 100. One or more of the security modes can be activated by the user, based on a scan of one or more of the user's fingers, the particular finger or fingers scanned, and the sequence of fingers scanned determining the security mode to be implemented. Further, the vehicle security system 100 enables the selection of one of a number of security modes. Each security mode can be configured to enable select functionalities such as a geographical containment or even disabling the vehicle 106. The vehicle security system 100 also provides for a selection of the danger level, preventing the occurrence of false alarms.

In the foregoing specification, the invention and its benefits and advantages have been described with reference to specific embodiments. However, one of ordinary skill in the art would appreciate that various modifications and changes can be made without departing from the scope of the present invention, as set forth in the claims below. Accordingly, the specification and figures are to be regarded in an illustrative rather than a restrictive sense, and all such modifications are intended to be included within the scope of the present invention. The benefits, advantages, solutions to problems, and any element(s) that may cause any benefit, advantage, or solution to occur or become more pronounced are not to be construed as critical, required or essential features or elements of any or all the claims. The invention is defined solely by the appended claims, including any amendments made during the pendency of this application and all the equivalents of the claims, as issued.

What is claimed is:

1. A method for securing a vehicle, the vehicle having a plurality of security modes, each of the plurality of security modes being associated with at least one of a plurality of fingers of a user of the vehicle, the method comprising:
scanning at least one finger of the user by a scanner;
determining a security mode to be implemented, based on the at least one finger scanned;
implementing the determined security mode; and
securing the vehicle based on the security mode.

2. The method according to claim 1, wherein implementing the determined security mode comprises enabling a normal mode that allows the vehicle to function normally.

3. The method according to claim 2, wherein the normal mode further comprises automatically activating a personalized user profile in the vehicle.

4. The method according to claim 1, wherein implementing the determined security mode comprises enabling an emergency mode that enables sending an emergency signal for assistance.

5. The method according to claim 4, wherein enabling the emergency mode further comprises sending the emergency signal continuously, the emergency signal comprising at least one of a position update of the vehicle, and a transmission allowing a Telematics service provider or a law enforcement agency to ascertain a present location of the vehicle.

6. The method according to claim 4, wherein enabling the emergency mode comprises configuring at least one danger level, the danger level requiring the scanning of a unique combination of the at least one of a plurality of fingers of the user to activate an alarm.

7. The method according to claim 6, wherein the at least one danger level is selected automatically, the selection being done utilizing a geographical location mapping.

8. The method according to claim 6, wherein the at least one danger level is set manually.

9. The method according to claim 1, wherein implementing the determined security mode comprises enabling a guest mode that allows the use of the vehicle by a non-registered user.

10. The method according to claim 9, wherein enabling the guest mode comprises enabling secondary features of the vehicle.

11. The method according to claim 10, wherein enabling the secondary features comprises at least one of the following:
a geographical containment of the vehicle;
a speed limitation of the vehicle; or
a vehicle occupancy verification feature wherein at least a subset of occupants in the vehicle verify their identity via the scanner.

12. The method according to claim 1, wherein implementing the determined security mode comprises enabling a vehicle disable mode that disables the functioning of the vehicle.

13. The method according to claim 1, wherein implementing the determined security mode comprises enabling a security disable mode that disables all security.

14. A vehicle security system comprising:
a scanner that is capable of scanning at least one finger of a user of a vehicle; and
a controller that is capable of implementing at least one of a plurality of security modes, each security mode being associated with at least one finger of the user of the vehicle; wherein the controller determines the security mode to be implemented, based on the at least one finger of the user that is scanned, and implements the determined security mode for securing the vehicle.

15. The system according to claim 14, wherein the controller further comprises a personalized profile module capable of automatically adjusting a personalized user profile active in the vehicle.

16. The system according to claim 14, wherein the plurality of security modes includes at least one of a normal mode, an emergency mode, a disable mode, a guest mode, and a security disable mode, the normal mode allowing the vehicle to function normally, the emergency mode allowing a transmission of an emergency signal, the disable mode allowing a disablement of the vehicle, the guest mode allowing the use of the vehicle by a non-registered user, and the security disable mode allowing all security to be disabled.

17. The system according to claim 16, wherein the controller is capable of sending emergency signals continuously in the emergency mode.

18. The system according to claim 16, wherein the controller further comprises a secondary module capable of enabling secondary features of the vehicle in the guest mode.

19. A method for securing a vehicle, the vehicle having a plurality of security modes including a normal mode and an emergency mode, the normal mode being associated with at least a first finger of a user of the vehicle, the emergency mode being associated with at least a second finger of the user, the method comprising:
scanning at least one finger of the user by a scanner;
selecting a security mode based on the at least one finger scanned, the normal mode being selected if the first finger is scanned, the emergency mode being selected if the second finger is scanned; and
securing the vehicle based on the security mode selected.

20. The method according to claim 19, wherein the security modes further include at least one of a guest mode and a disable mode, the guest mode being capable of enabling the use of the vehicle by a non-registered user, the guest mode being associated with at least a third finger of the user, and the disable mode being capable of disabling the vehicle, the disable mode being associated with at least a fourth finger of the user.
